(19) United States
(12) Patent Application Publication
(10) Pub. No.: US 2007/0085286 A1
(43) Pub. Date: Apr. 19, 2007

(54) Infant stroller with vibration

(76) Inventor: Steven Gibree, Slatersville, RI (US)

Correspondence Address: IP STRATEGIES, 12 1/2 WALL STREET, SUITE I, ASHEVILLE, NC, 28801, US

(21) Appl. No.: 11/520,492

(22) Filed: Sep. 12, 2006

Related U.S. Application Data
(60) Provisional application No. 60/716,069, filed on Sep. 12, 2005.

(51) Int. Cl. B62B 7/00

(52) U.S. Cl. 280/47.38

(57) ABSTRACT

A stroller includes a child-receiving seat, a frame coupled to the seat, one or more wheels coupled to the frame, and a vibration mechanism disposed to impart a vibrating motion to the seat.

### CROSS-REFERENCE TO RELATED APPLICATION

This claims the benefit under 35 USC §119(e) of U.S. Provisional Patent Application 60/716,069, which was filed on Sep. 12, 2005.

### FIELD OF THE INVENTION

The present invention relates to strollers for infants and small children, as well as other mobile child carrier. As used herein, the term “strollers” shall include any mobile child carrier, whether transportable along the ground on wheels or by any other mechanism.

### BACKGROUND OF THE INVENTION

Strollers are commonly used for transporting babies and small children. Often a child will get fidgety if kept in the stroller too long, or if the child is in the stroller during what is typically his/her nap time. Some strollers include accessories that are intended as distractions for the child, to capture his/her attention and keep him/her occupied. However, sometimes these accessories are not enough to prevent the child from getting cranky, and sometimes the parent or caretakers would prefer that the child sleep while in the stroller.

Bouncers are well-known child seats that are used in the home. These seats include a vibrational element that soothes the seated child and sometimes induces sleep. It would be advantageous to incorporate such a vibrational element in a stroller design.

### BRIEF DESCRIPTION OF THE INVENTION

The present invention is a stroller that includes such a vibrational element. According to an aspect of the invention, the stroller includes a child-receiving seat, a frame coupled to the seat, one or more wheels coupled to the frame, and a vibration mechanism disposed to impart a vibrating motion to the seat.

The seat can be removably coupled to the frame.

The seat can include fabric. The vibration mechanism can be sewn into the fabric.

The seat can include a rigid frame. The vibration mechanism can be coupled to the rigid frame. For example, the vibration mechanism can be disposed to impart vibration to the rigid frame. The seat can include a fabric cover fitted over the rigid frame. In this case, the vibration mechanism can be disposed between the rigid frame and the fabric cover. The vibration mechanism can be sewn into the fabric cover. The rigid frame can include a plurality of components. The vibration mechanism can cause at least one of the components to move relative to at least one other of the components.

The seat can include a rigid support structure, and the vibration mechanism can be coupled to the rigid support structure. For example, the vibration mechanism can be disposed to impart vibration to the rigid support structure. The seat can include a fabric cover disposed over the rigid support structure. The vibration mechanism can be disposed between the rigid support structure and the fabric cover. The vibration mechanism can be sewn into the fabric cover. The rigid support structure can include a plurality of components. In this case, the vibration mechanism can cause at least one of the components to move relative to at least one other of the components.

The vibration mechanism can include a switch by which the vibration mechanism is manually actuated. The switch can be disposed on the frame. The frame can include a handle, in which case the switch can be disposed on the handle. The switch can be communicatively coupled to the vibration mechanism by a cable. Alternatively, the switch can be wirelessly coupled for communication with the vibration mechanism.

The stroller can also include a motion sensor that senses motion of the stroller. In this case, the stroller can also include a switch by which the vibration mechanism is automatically actuated when the motion sensor senses that the motion of the stroller has stopped. The stroller can include a timing circuit that controls deactivation of the vibration mechanism. The timing circuit can cause gradual decreasing of vibration amplitude prior to deactivation.

### BRIEF DESCRIPTION OF THE DRAWINGS

FIG. 1 is an illustration of an exemplary embodiment of a stroller according to the invention.

FIG. 2 is an illustration of another exemplary embodiment of a stroller according to the invention, including a fabric seat.

FIG. 3 is an illustration of another exemplary embodiment of a stroller according to the invention, wherein the seat includes a fabric covered frame.

### DETAILED DESCRIPTION OF THE INVENTION

The present invention is a stroller that includes such a vibrational element. This element can be attached to the seat portion of the stroller, to the frame of the stroller, to the handle of the stroller, or to any convenient location that will allow the vibration produced by the element to be imparted to the seated child. It is contemplated that this vibrational element can provide a vibration motion to the entire seat portion of the stroller, or to any advantageous portion(s) or component(s) of the seat portion. Further, the vibrational element preferably can be adjusted to provide a variable amount of vibrational motion and/or to provide a variable frequency of vibrational motion. The vibrational element can be powered by a typical disposable battery, by a rechargeable battery or fuel cell, or by any portable power source.

The vibrational element can be fabricated integrally with the stroller, such that it is permanently attached to the stroller or is constructed as part of the stroller or one of the stroller components. For example, the vibrational element can form part of the frame, handle, seat, or other component of the stroller. Alternatively, the invention can be embodied solely as the vibrational element, which is adapted to be coupled to a conventional stroller as a retrofit or as an optional accessory. The vibrational element can have a fixed shape and size, such as would be the case if it is fabricated in a hard enclosure, with attachment means for attaching to a component of the stroller, or otherwise coupling to the stroller in order to impart vibrational movement. Alternatively, the vibrational element can be a soft or pliable device that can be wrapped around a component of the stroller or that can be adapted, for example, to the contour of the seat portion of the stroller. Alternatively, the vibrational element can be encased in a soft lining, for example, to be used as the inner lining of the seat portion of the stroller, so as to provide a soft vibrational surface for the seated child.

The controls for the vibrational element, such as the on/off control and controls for any of the vibrational parameters, can be located directly on the working component of the vibrational element, or can be located remotely from the working component. For example, if the vibration element lines the seat portion of the stroller, the controller for the vibration element can be attached to the handle of the stroller, for easy access and manipulation by the person pushing the stroller. The controller component can be connected to the working component by a cable, which can be used to provide control signals from the controller component to the working component. Alternatively, the controller component can provide a wireless signal to the working component, such as by a signal on a radio frequency or infrared carrier.

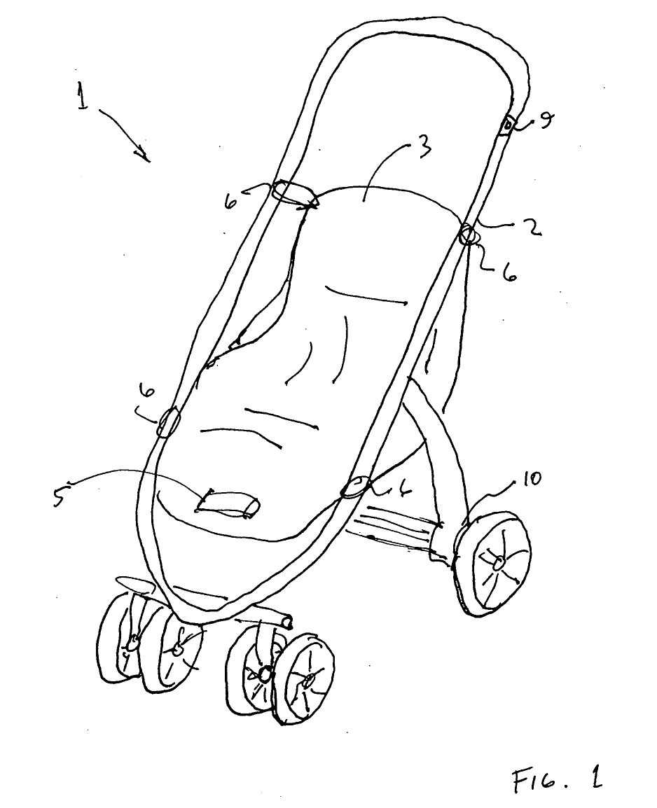

As shown in FIG. 1, an exemplary embodiment of the stroller 1 includes a frame 2, a child-receiving seat 3, and a vibration mechanism 5. The vibration mechanism 5 is shown coupled to the seat 3. In general, the vibration mechanism 5 can be disposed anywhere on the stroller 1, coupled in communication with the seat 3 so as to impart a vibrating motion to the seat 3.

The seat 3 can be fixed to the frame 2, or can be removably coupled to the frame 2. For example, the seat 3 or the frame 2, or both, can include connectors 6 that allow the seat 3 to be firmly attached to the frame 2, and to be easily removed from the frame 2. It is contemplated that the removable seat 3 can also be reattached to the frame 2 in more than one position. Once removed, the seat 3 can function as a stationary child seat, a baby carrier, or even a bouncer if the vibration mechanism 5 remains coupled to the seat 3 on removal from the frame 2.

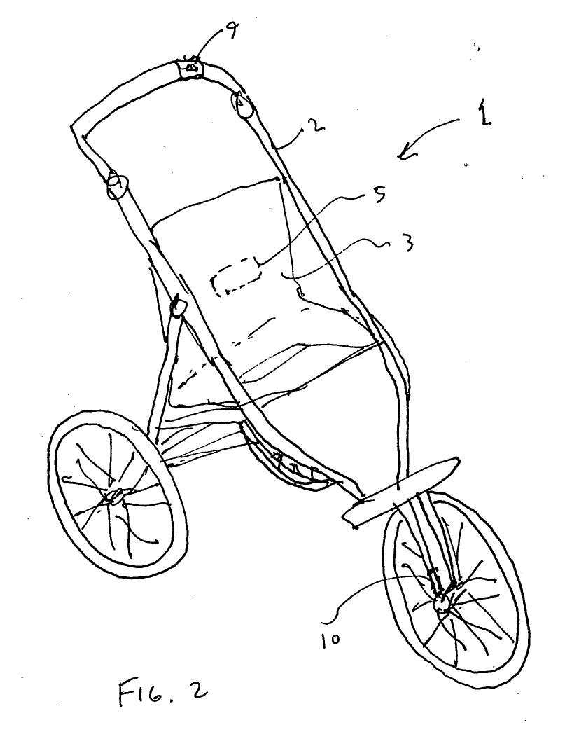

According to the embodiment shown in FIG. 2, the seat 3 can be made of fabric, or primarily of fabric. For example, the seat 3 can be a sling-type fabric seat that provides support for the child. In this case, the vibration mechanism 5 can be, for example, sewn into the fabric of the seat 3, or the vibration mechanism 5 can be touching the frame 2 or a frame for the fabric seat, or can otherwise be in mechanical communication with the seat 3. The vibration mechanism 5 can be disposed elsewhere on the stroller 1, as long as the vibrating motion is imparted to the seat 3.

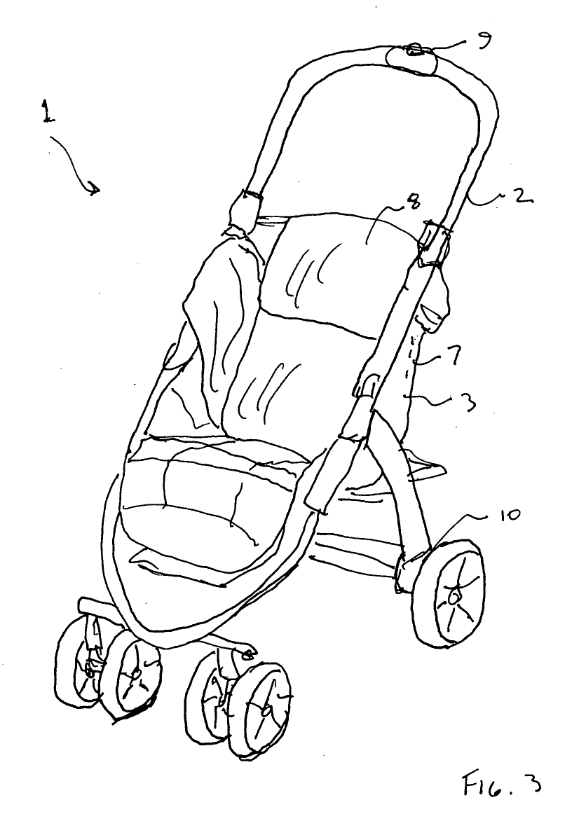

According to the embodiment shown in FIG. 3, the seat 3 can include a rigid frame 7, with a fabric cover 8 fitted over the frame 7. The vibration mechanism 5 can be attached to the rigid frame 7 as shown, so as to impart vibration to the rigid frame 7 and therefore indirectly to the child. The placement of the vibration mechanism 5 shown in the figure is exemplary only; any placement on the frame 7 that would provide a vibrating sensation to the child is contemplated. Alternatively, the vibration mechanism 5 can be disposed between the rigid frame 7 and the fabric cover 8, or can be sewn into the fabric cover 8, either to impart vibration directly to the child through the fabric, or to impart vibration to the rigid frame 7 and indirectly to the child. It is also contemplated that he rigid frame 7 can include a number of components that can move or flex relative to each other. In such embodiments, the vibration mechanism 5 can cause at least one of the components to move relative to at least one of the other components, thereby providing a vibrating or massaging motion to the child.

Alternatively, the seat 3 can include a rigid support structure, such as a hard shell forming the surface of the seat 3. The vibration mechanism 5 can be attached to the rigid support structure as shown, such as to impart vibration to the rigid support structure and therefore indirectly to the child. The seat 3 can include a fabric cover disposed over the rigid support structure, provided for the comfort of the child. In this case, the vibration mechanism 5 can be disposed, for example, between the rigid support structure and the fabric cover. Alternatively, the vibration mechanism 5 can be sewn into the fabric cover, either to impart vibration directly to the child through the fabric, or to impart vibration to the rigid support structure and indirectly to the child. It is also contemplated that the rigid support structure can include a number of components that can move or flex relative to each other. In such embodiments, the vibration mechanism 5 can cause at least one of the components to move relative to at least one of the other components, thereby providing a vibrating or massaging motion to the child.

As shown in FIGS. 1-3, the vibration mechanism 5 can be manually actuated by a switch included on the mechanism. Alternatively, or in addition, the switch 9 can be disposed on the frame 2, for remote actuation of the mechanism 5, either in wired or wireless fashion. Placement of the switch 9 on the frame 2 would make it easier for some adult supervisors to actuate and turn off the mechanism 5, particularly when the stroller is in motion. Actuation by other than manual means as an alternative, or in addition, is also contemplated, as described below.

The stroller 1 can include a motion sensor, in communication with the vibration mechanism 5 or as a part of the vibration mechanism 5, which senses motion of the seat 3, preferably as the stroller is being pushed. For example, the motion sensor 10 can be located on the frame 2, as shown in FIGS. 1-3, and can sense motion of the frame 2 and therefore of the seat 3. This embodiment also includes a switch by which the vibration mechanism 5 is automatically actuated when the motion sensor 10 senses that motion of the seat 3 has stopped. Thus, if the adult supervisor stops pushing the stroller, the vibration mechanism can begin to calm the child automatically.

The stroller 1 can also include a timing circuit, preferably embodied as an internal component of the vibration mechanism 5, that controls deactivation of the vibration mechanism 5. The timing circuit can be used to provide any of several functions. For example, the timing circuit can control actuation and/or deactivation of the vibration mechanism 5, so as to provide an automatic vibration start time, an automatic vibration switch-off, or a timed cycling of the vibration motion. Alternatively, or in addition, the timing circuit can cause gradual decreasing of the vibration amplitude prior to deactivation.

Thus, the present invention is a stroller that includes a mechanism for providing a vibrating motion to the infant seated in the stroller. When the stroller motion stops, the vibrating sensation can continue to soothe the infant, although the vibrating motion can be provided to the child at any time. This vibrating motion can be similar to that used in child bouncers, and the seat can be detached to be used independently as a carrier, seat, or bouncer. The vibrating motion can be provided by a mechanism included in or attached to the infant seat, or disposed otherwise on the stroller.

The present invention is not limited in scope to any particular type of infant stroller. Four-wheeled, three-wheeled, push strollers, and mechanized strollers can include the vibration feature of the present invention, as can strollers that use a different type of motive contact than wheels.

I claim:

1. A stroller, comprising:
a child-receiving seat;
a frame coupled to the seat;
one or more wheels coupled to the frame; and
a vibration mechanism disposed to impart a vibrating motion to the seat.

2. The stroller of claim 1, wherein the seat is removably coupled to the frame.

3. The stroller of claim 1, wherein the seat includes fabric.

4. The stroller of claim 3, wherein the vibration mechanism is sewn into the fabric.

5. The stroller of claim 1, wherein the seat includes a rigid frame.

6. The stroller of claim 5, wherein the vibration mechanism is coupled to the rigid frame.

7. The stroller of claim 5, wherein the vibration mechanism is disposed to impart vibration to the rigid frame.

8. The stroller of claim 5, wherein the seat includes a fabric cover fitted over the rigid frame.

9. The stroller of claim 8, wherein the vibration mechanism is disposed between the rigid frame and the fabric cover.

10. The stroller of claim 8, wherein the vibration mechanism is sewn into the fabric cover.

11. The stroller of claim 5, wherein the rigid frame includes a plurality of components.

12. The stroller of claim 1, wherein the vibration mechanism causes at least one of the components to move relative to at least one other of the components.

13. The stroller of claim 1, wherein the seat includes a rigid support structure.

14. The stroller of claim 13, wherein the vibration mechanism is coupled to the rigid support structure.

15. The stroller of claim 13, wherein the vibration mechanism is disposed to impart vibration to the rigid support structure.

16. The stroller of claim 13, wherein the seat includes a fabric cover disposed over the rigid support structure.

17. The stroller of claim 16, wherein the vibration mechanism is disposed between the rigid support structure and the fabric cover.

18. The stroller of claim 16, wherein the vibration mechanism is sewn into the fabric cover.

19.

20. The stroller of claim 13, wherein the rigid support structure includes a plurality of components.

21. The stroller of claim 20, wherein the vibration mechanism causes at least one of the components to move relative to at least one other of the components.

22. The stroller of claim 1, wherein the vibration mechanism includes a switch by which the vibration mechanism is manually actuated.

23. The stroller of claim 22, wherein the switch is disposed on the frame.

24. The stroller of claim 23, wherein the frame includes a handle.

25. The stroller of claim 24, wherein the switch is disposed on the handle.

26. The stroller of claim 23, wherein the switch is communicatively coupled to the vibration mechanism by a cable.

27. The stroller of claim 23, wherein the switch is wirelessly coupled for communication with the vibration mechanism.

28. The stroller of claim 1, further comprising a motion sensor that senses motion of the stroller.

29. The stroller of claim 28, further comprising a switch by which the vibration mechanism is automatically actuated when the motion sensor senses that the motion of the stroller has stopped.

30. The stroller of claim 1, further comprising a timing circuit that controls deactivation of the vibration mechanism.

31. The stroller of claim 30, wherein the timing circuit causes gradual decreasing of vibration amplitude prior to deactivation.
